(19) United States
(12) Patent Application Publication
(10) Pub. No.: US 2006/0284837 A1
(43) Pub. Date: Dec. 21, 2006

(54) Hand shape recognition apparatus and method

(76) Inventors: Bjorn Stenger, Kanagawa (JP); Tsukasa Ike, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/448,802

(22) Filed: Jun. 8, 2006

(30) Foreign Application Priority Data
Jun. 13, 2005 (JP) 2005-172340

(51) Int. Cl. G09G 5/00

(52) U.S. Cl. 345/156

(57) ABSTRACT

A similarity calculation unit calculates a similarity between a hand candidate area image and a template image. A consistency probability calculation unit and an inconsistency probability calculation unit use probability distributions of similarities of a case where hand shapes of the template image and the hand candidate area image are consistent with each other and a case where they are not consistent, and calculate a consistency probability and an inconsistency probability of hand shapes between each of the template images and the hand candidate area image. A hand shape determination unit determines a hand shape most similar to the hand candidate area image based on the consistency probability and the inconsistency probability calculated for each hand shape, and outputs it as a recognition result.

### CROSSREFERENCE TO RELATED APPLICATIONS

This application is based upon and claims the benefit of priority from the prior Japanese Patent Application No. 2005-172340, filed on Jun. 13. 2005; the entire contents of which are incorporated herein by reference.

### TECHNICAL FIELD

The present invention relates to hand shape recognition, and particularly to a hand shape recognition apparatus and method in which a hand shape can be recognized by image processing.

### BACKGROUND OF THE INVENTION

As a new human interface technique in equipment such as a computer, which substitutes for a keyboard or a mouse, a gesture recognition technique to give instructions to the equipment by gestures has been researched and developed.

Particularly, in recent years, for the purpose of reducing the load of a user caused by using an apparatus such as a dataglove, research and development has been vigorously conducted on a technique to recognize the shape of a user's hand coming within the range of a video camera by performing image processing on an image captured by the video camera.

For example, Japanese Application Kokai 2001-307107 discloses a technique in which the position of a hand is detected by using information of a skin-colored area or the like from a camera image, and the grasping operation or waving operation of the user's hand is recognized from the position of the hand and the movement of its surrounding pixels.

Besides, for example, Japanese Application Kokai 2001-56861 discloses a technique in which a hand area image on the finger side with respect to a wrist is extracted from a given hand image, and this is projected on an eigenspace generated from an example image based on an eigenspace method, so that the most similar hand shape is obtained.

However, in the technique disclosed in Japanese Application Kokai 2001-307107, since only the movement of pixels is used for the identification of a gesture, the kinds of recognizable gestures are limited to what can be judged from a change in movement, such as grasping of a hand or waving thereof, and a difference in hand shape can not be identified.

Besides, in the technique disclosed in Japanese Application Kokai 2001-56861, although a difference in hand shape can be identified by using the eigenspace method, a description is not given to a case where a hand area of a recognition object can not be suitably extracted from an input image. In the case where it is difficult to suitably extract a hand area as a recognition object, for example, in the case where there is another object around and behind a hand, or in the case where the color of a hand is seen to be changed by an illumination condition, it is conceivable that when the image of the hand area is projected on the eigenspace, it is not projected on a suitable position, and there is a high possibility that erroneous recognition occurs.

The present invention has been made in view of the above problems, and provides a hand shape recognition apparatus and method in which a hand shape can be recognized at high precision even in the case where it is difficult to suitably extract a hand area as a recognition object, for example, in the case where there is another object around and behind a hand, or in the case where the color of a hand is seen to be changed by an illumination condition.

### BRIEF SUMMARY OF THE INVENTION

According to embodiments of the present invention, an apparatus for recognizing a shape of a human hand includes an image input unit configured to input an image containing the human hand, a hand candidate area detection unit configured to detect a hand candidate area from the input image, a template storage unit configured (1) to store a plurality of template images and a plurality of consistency probability distributions, the template images relating to a plurality of hand shapes, the consistency probability distributions corresponding to the respective template images, each of the consistency probability distributions indicating a probability distribution based on a distribution of first similarities between each of the template images and a plurality of example hand area images each containing a hand shape consistent with the hand shape of the respective template image, and a hand shape recognition unit configured (1) to calculate second similarities between the hand candidate area image and each of the template images relating to the respective hand shapes, (2) to calculate plural consistency probabilities that each of the second similarities is included in the consistency probability distribution corresponding to each of the template images relating to the respective hand shapes, and (3) to obtain a hand shape most similar to the hand candidate area image based on the plural consistency probabilities.

According to the embodiments of the invention, the hand shape recognition apparatus can be realized in which the hand shape can be recognized even in the case where it is difficult to suitably extract the hand area of a recognition object, for example, in the case where an object exists around and behind the hand, or in the case where the color of a hand is seen to be changed by an illumination condition.

### BRIEF DESCRIPTION OF THE DRAWINGS

FIG. 1 is a block diagram of a hand shape recognition apparatus of a first embodiment of the invention.

FIG. 2 is a block diagram showing a structure of a hand candidate area detection unit 2.

FIG. 3 is a block diagram showing another structure of the hand candidate area detection unit 2.

FIG. 4 is a block diagram showing a structure of a template creation/storage unit 3.

FIG. 5 is a block diagram showing a structure of a similarity calculation unit 32.

FIG. 6 is a block diagram showing a structure of a gesture recognition unit 4.

FIG. 7 is a flowchart for explaining a template creation/storage processing.

FIG. 8 is a flowchart for explaining a similarity calculation processing of step S33 of FIG. 7.

FIG. 9 is a view for explaining vector creation from a pattern image.

FIG. 10 is a view for explaining vector creation from a contour image.

FIG. 11 is a view showing an example of a consistency probability distribution created in a consistency probability distribution creation unit 33.

FIG. 12 is a flowchart for explaining a gesture recognition processing.

FIG. 13 is a block diagram of a hand shape recognition apparatus of a second embodiment.

FIG. 14 is block diagram showing a structure of a template creation/storage unit 5.

FIG. 15 is a block diagram showing a structure of a gesture recognition unit 6.

FIG. 16 is a flowchart for explaining a template creation/storage processing performed in the template creation/storage unit 5.

FIG. 17 is a view showing a two-dimensional distribution of similarities obtained in the case where two kinds of features, a pattern of a hand and a contour thereof, are used.

FIG. 18 is a flowchart for explaining a gesture recognition processing performed in the gesture recognition unit 6.

FIG. 19 is a block diagram of a hand shape recognition apparatus of a third embodiment.

FIG. 20 is a block diagram showing a structure of a gesture recognition unit 7.

FIG. 21 is a view for explaining transformations of templates.

FIG. 22 is flowchart for explaining a gesture recognition processing performed in the gesture recognition unit 7.

### DETAILED DESCRIPTION OF THE INVENTION

Hereinafter, a hand shape recognition apparatus of embodiments of the invention will be described with reference to the drawings.

### First Embodiment

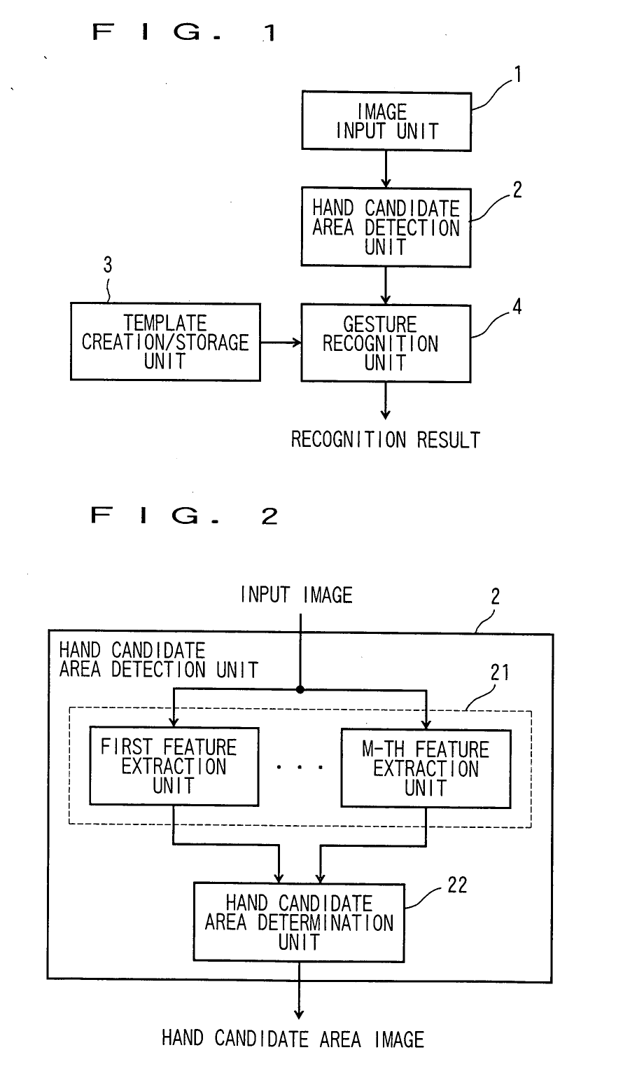

Hereinafter, a hand shape recognition apparatus of a first embodiment will be described with reference to FIGS. 1 to 12.

[1] Structure of the Hand Shape Recognition Apparatus

FIG. 1 is a block diagram showing a structure of the hand shape recognition apparatus according to the first embodiment.

An image input unit 1 takes an image including a user's hand by using an imaging device such as, for example, a CMOS image sensor or a CCD image sensor, and supplies it to a hand candidate area detection unit 2.

The hand candidate area detection unit 2 detects an area where a hand seems to be included (hereinafter referred to as “hand candidate area”) from the image captured by the image input unit 1, and extracts an image of the hand candidate area (hereinafter referred to as “hand candidate area image”).

A template creation/storage unit 3 creates and stores templates corresponding to respective hand shapes to be recognized.

With respect to the hand candidate area image created by the hand candidate area detection unit 2, a gesture recognition unit 4 uses the templates corresponding to the respective hand shapes stored in the template creation/storage unit 3 to determine a hand shape most similar to the hand candidate area image, and outputs it as a recognition result.

The functions of the respective units 1 to 4 of the hand shape recognition apparatus described above can be realized by a program stored in a computer.

[2] Hand Candidate Area Detection Unit 2

[2-1] First Example of the Hand Candidate Area Detection Unit

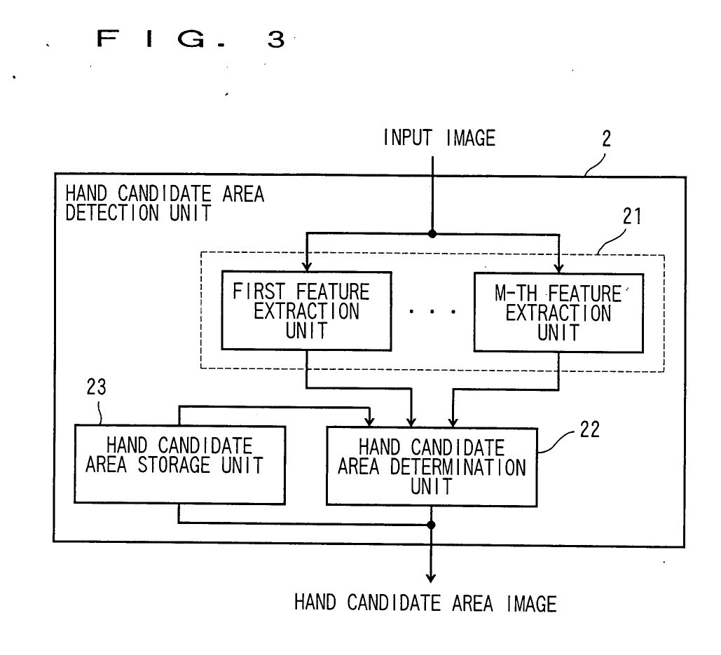

The hand candidate area detection unit 2 will be described with reference to FIG. 2. FIG. 2 shows a first example of a structure of the hand candidate area detection unit 2.

A feature extraction unit 21 performs at least one kind of image processing on the image supplied from the image input unit 1 to create m kinds of feature images (m>=1), and supplies them to a hand candidate area determination unit 22. As features to be extracted, various features generally used in image processing or the like may be used. Here, as an example, a description will be given to a case in which “skin-colored area information” and “movement information” are used.

The “skin-colored area information” is obtained in such a manner that with respect to each of pixels constituting the input image, the pixel value is mapped into a YUV color space, and a U value and a V value as its color difference component is used to calculate a probability that it is skin-colored. In the calculation of the probability, from an example image in which a skin-colored area is previously known, there is calculated the probability that it is skin-colored when a certain U value and V value are observed.

The “movement information” is obtained in such a manner that a difference between an image of the present frame and an image of the former frame is calculated for each pixel, and a probability that a movement exists in the pixel is calculated from the magnitude of the absolute value of the difference.

The hand candidate area determination unit 22 determines from the m kinds of feature images created by the feature extraction unit 21 that an area where the probability that the hand exists is high is a hand candidate area, extracts an image in the hand candidate area from the input image, and outputs it as a hand candidate area image.

When the area where the probability that the hand exists is high is determined, for example, as in the example described before, in the case where the features are obtained as the probabilities, a mixture of normal distribution of these is obtained, the probability that the hand exists is evaluated based on this, and the area where the probability is a threshold value or higher is obtained. The invention is not limited to the method described here, and for example, a method in which an area extracted as a skin-colored area is made a hand candidate area may be used. The “skin-colored area” can be extracted from an area where a color component is included within a previously determined reference range of flesh color.

[2-2] Second Example of the Hand Candidate Area Detection Unit 2

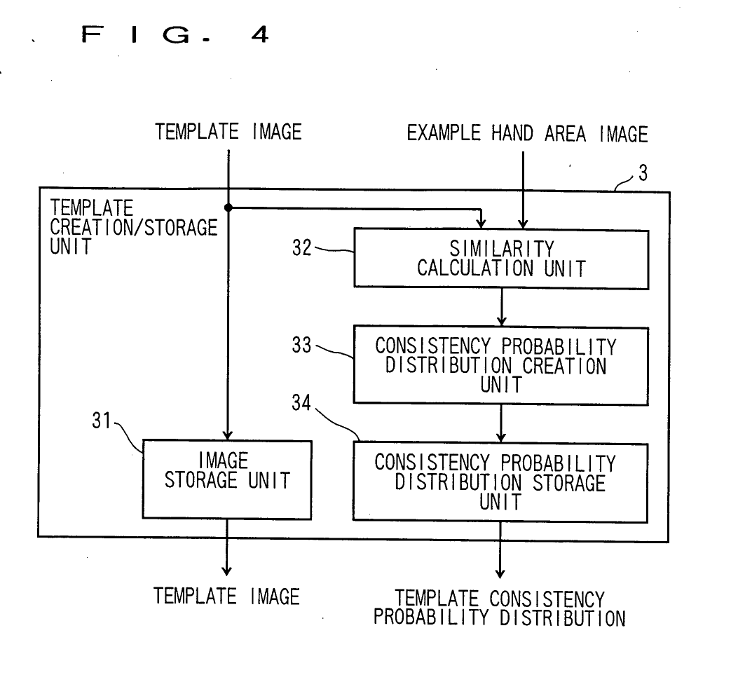

FIG. 3 shows a second example of the hand candidate area detection unit 2. The structure of FIG. 3 is different from the first example of FIG. 2 in that a hand candidate area storage unit 23 is added.

The hand candidate area storage unit 23 stores a coordinate value of a hand candidate area determined in a hand candidate area determination unit 22, and supplies the coordinate value to the hand candidate area determination unit 22 in a next frame.

The position of the hand candidate area in the former frame stored here is effective in the case where all features can not be suitably extracted in a feature extraction unit 21 when the position of the hand candidate area is calculated. In general, since the position of the hand is not changed very much between frames, the position detection precision of the hand candidate area can be raised by using the position of the hand candidate area in the former frame.

[3] Template Creation/Storage Unit 3

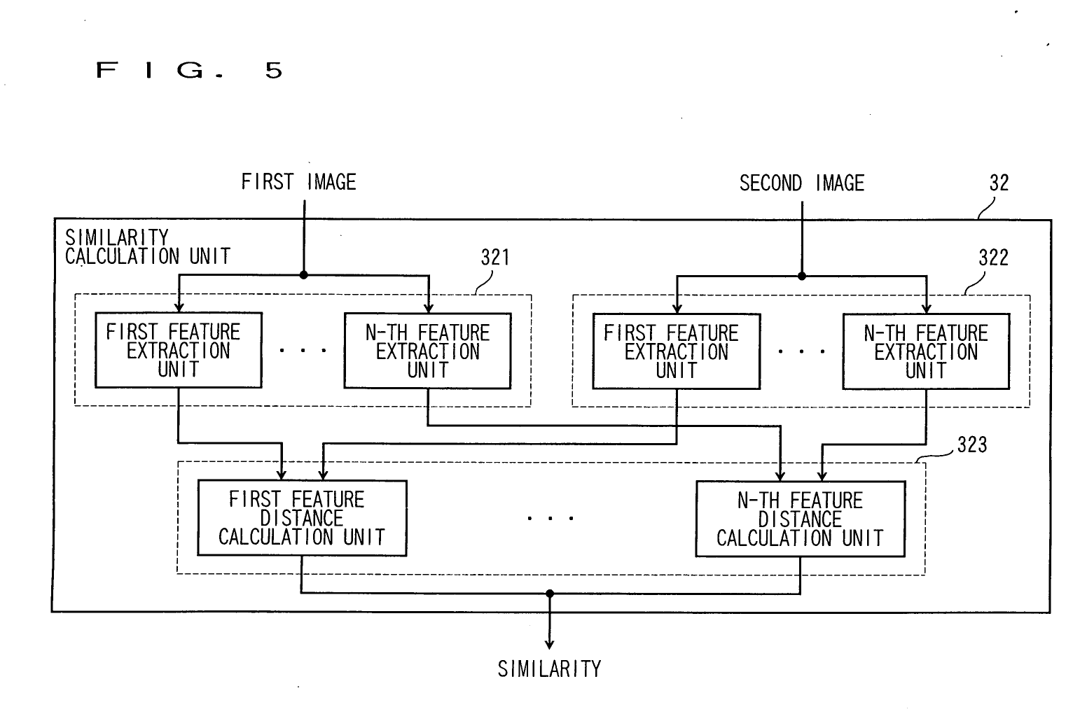

FIG. 4 shows an example of a structure of the template creation/storage unit 3.

[3-1] Structure of the Template Creation/Storage Unit 3

An image storage unit 31 stores a corresponding template image for each hand shape. Here, the “template image” is an image obtained by capturing a hand having a corresponding shape under suitable illumination and in an environment where there is no pattern or the like in the background.

A similarity calculation unit 32 evaluates similarity between a template image and an image (hereinafter referred to as “example hand area image”) which is captured in a general environment where there is an object or the like in the background and in which the hand shape is already known, and outputs the result as a similarity. It is assumed that one or more arbitrary number of example hand area images exist for each hand shape, and the similarity to the corresponding template image is calculated for each of them. Besides, it is assumed that the example hand area image is normalized to the same size as the template image. When described in more detail, attention is paid to that in the example hand area images, there are plural images in which the backgrounds are different from one another though the hand shapes are the same, and since the backgrounds are different from one another in the example hand area images having the same hand shape as the template image, the similarities to the template image are different from one another.

For each hand shape, from the similarities between the template image and the example hand area images calculated in the similarity calculation unit 32, a consistency probability distribution creation unit 33 creates a probability distribution (hereinafter referred to as “consistency probability distribution”) of similarities outputted by the similarity calculation unit 32 in the case where the hand shape of the hand area image is consistent with the hand shape of the template image.

A consistency probability distribution storage unit 34 stores, as a template consistency probability distribution, the consistency probability distribution created in the consistency probability distribution creation unit 33 and corresponding to each hand shape.

[3-2] Similarity Calculation Unit 32

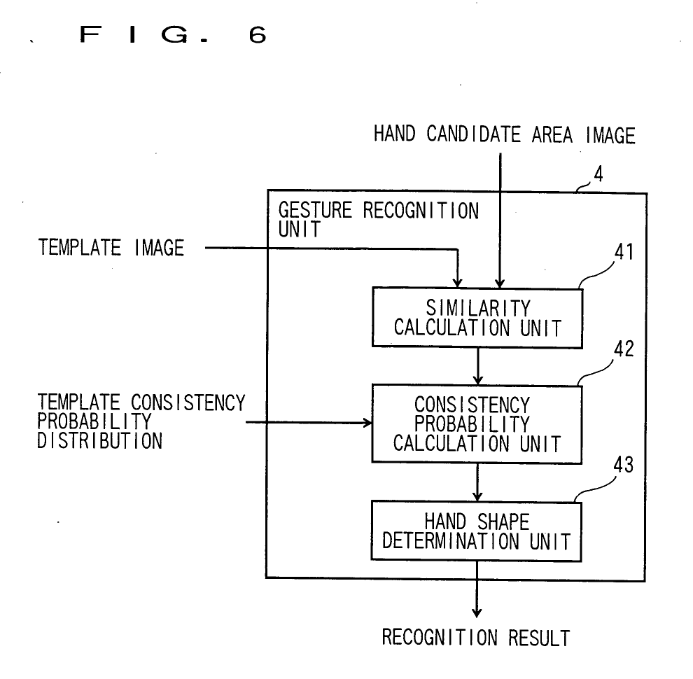

FIG. 5 shows an example of a structure of the similarity calculation unit 32.

A feature extraction unit 321 performs at least two kinds of image processings on a first image given as an input to create n kinds of feature images (n>=2), and supplies them to a feature distance calculation unit 323.

A feature extraction unit 322 performs at least two kinds of image processings on a second image given as an input to create n kinds of feature images (n>=2), and supplies them to the feature distance calculation unit 323. Here, it is assumed that the kind of the created feature information is the same as that of the feature extraction unit 321.

With respect to the feature images created in the feature extraction units 321 and 322, the feature distance calculation unit 323 calculates, as distances, differences between them for the respective kinds of the features, and outputs a similarity having these n distances as elements.

[4] Gesture Recognition Unit 4

FIG. 6 shows an example of a structure of the gesture recognition unit 4.

A similarity calculation unit 41 calculates similarities between the hand candidate area image extracted in the hand candidate area detection unit 2 and the respective template images stored in the image storage unit 31 of the template creation/storage unit 3 for the respective hand shapes. It is assumed that the similarity calculation unit 41 has the same function as the similarity calculation unit 32 constituting the template creation/storage unit 3.

A consistency probability calculation unit 42 calculates probabilities that the respective hand shapes are included in the hand candidate area image from the similarities calculated in the similarity calculation unit 41 and the template consistency probability distributions stored in the consistency probability distribution storage unit 34 of the template creation/storage unit 3.

A hand shape determination unit 43 selects the highest probability from the probabilities of the respective hand shapes calculated in the consistency probability calculation unit 42 and outputs the corresponding hand shape as a recognition result.

[5] Template Creation/Storage Processing

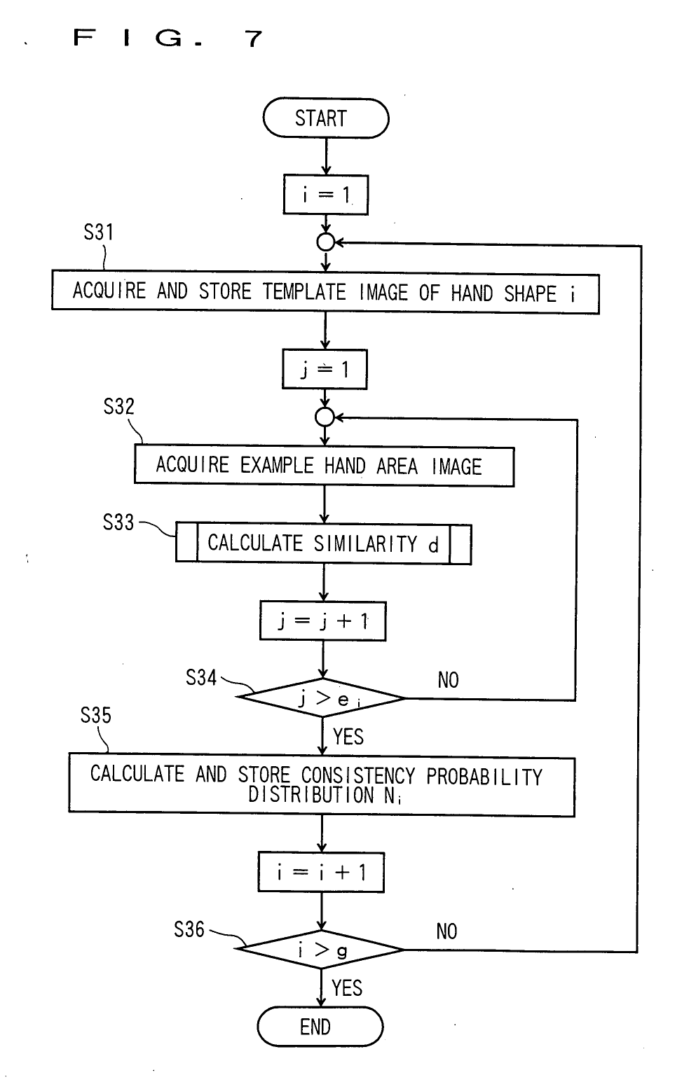

Next, a template creation/storage processing to be executed by the template creation/storage unit 3 will be described with reference to a flowchart of FIG. 7. Incidentally, in FIG. 7, the number of kinds of hand shapes to be recognized is made g, and the number of example hand area images corresponding to the i-th hand shape is made eᵢ (1=<i=<g). That is, eᵢ images are provided which have the same hand shape i and are different from each other in the background.

[5-1] Steps S31 to S34

At step S31, the template creation/storage unit 3 acquires the template image corresponding to the hand shape i, and stores it in the image storage unit 31. At the same time, the acquired template image is supplied as the first image in the similarity calculation unit 32.

At step S32, the template creation/storage unit 3 acquires one example hand area image which is previously known to have the hand shape i, and supplies it as the second image in the similarity calculation unit 32.

At step S33, the similarity calculation unit 32 calculates the similarity d between the two supplied images.

The processing of the above steps S32 to S33 are performed for each of the eᵢ example hand area images, so that eᵢ similarity values are obtained. That is, even if the images have the same hand shape i, when the backgrounds are different from each, the similarities are also different from each other.

[5-2] Similarity Calculation Processing

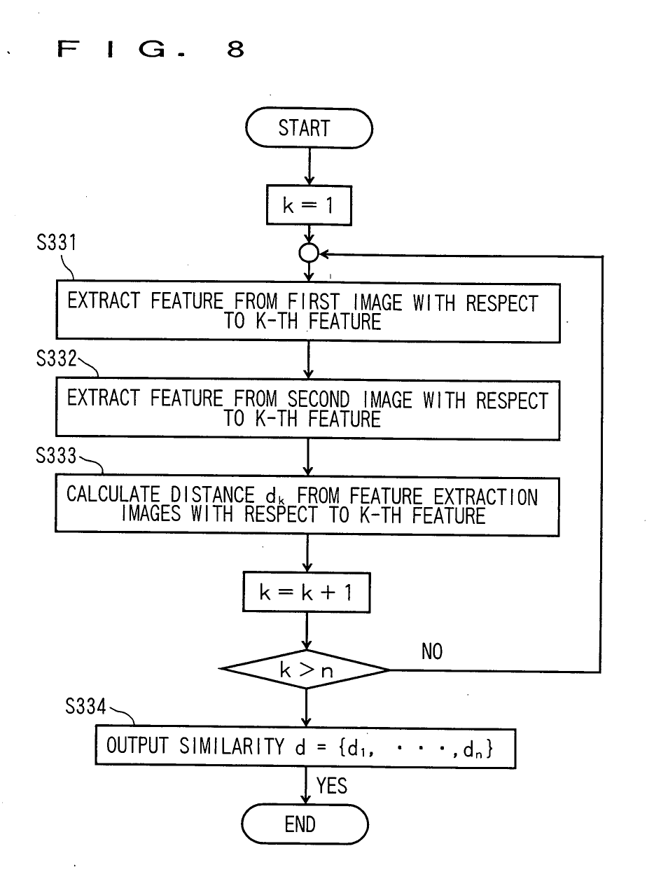

Here, a similarity calculation processing to be executed by the similarity calculation unit 32 will be described with reference to a flowchart of FIG. 8.

[5-2-1] Steps S331 to S334

At step S331, the feature extraction unit 321 performs the feature extraction processing on the k-th feature from the first image (template image), and supplies the image representing the k-th feature of the hand to the feature distance calculation unit 323.

At step S332, the feature extraction unit 322 performs the feature extraction processing on the k-th feature from the second image (example hand area image), and supplies the image representing the k-th feature of the hand to the feature distance calculation unit 323.

At step S333, the feature distance calculation unit 323 calculates, as a distance dₖ on the k-th feature, the difference between the two processing result images obtained on the k-th feature.

The processing of the above steps S331 to S333 are performed for the first to n-th features, so that n distances {d₁, . . . , dₙ} are calculated.

At step S334, the similarity d={d₁, . . . , dₙ} having, as elements, the above calculated distances on the first to n-th features in the template image and the example hand area image is outputted, and the similarity calculation processing is ended.

[5-2-2] Similarity Calculation Processing

As the features used in the similarity calculation processing, various features generally used in image processing or the like may be used. Here, as an example, a case where a pattern of a hand and a contour thereof are used as the features will be described.

A feature image to represent the pattern of the hand is created by performing an edge extraction processing on each of the first image and the second image at step S331 and step S332. Here, as a method of edge extraction, for example, by using a method based on Oriented Edge Energy disclosed in non-patent document 1 (D Martin et al, “Learning to detect natural image boundaries using local brightness, color, and texture cues,” IEEE Trans. Pattern Analysis and machine Intelligence, 26(5), 530-549, 2004), the pattern of an image can be stably extracted under various environments. However, the invention is not limited to the above method, but can use various generally used edge extraction methods.

A feature image to represent the contour of the hand is created by performing a skin-colored area extraction processing on each of the first image (template image) and the second image (example hand area image) at step S331 and step S332. Here, as a method of the skin-colored area extraction processing, for example, a method is conceivable in which RGB values of respective pixels constituting an image are converted into YUV values, and a monochrome image is formed in which a pixel seemed to be skin-colored is made to have a pixel value of 1 and another pixel is made to have a pixel value of 0 from U values and V values as color difference components. As the judgment of “pixel seemed to be skin-colored”, for example, there is conceivable a method of judging that an area where the probability is a threshold value or higher is skin-colored, or a method of judging that a pixel where YUV values are within the range of previously determined skin-colored standard is skin-colored.

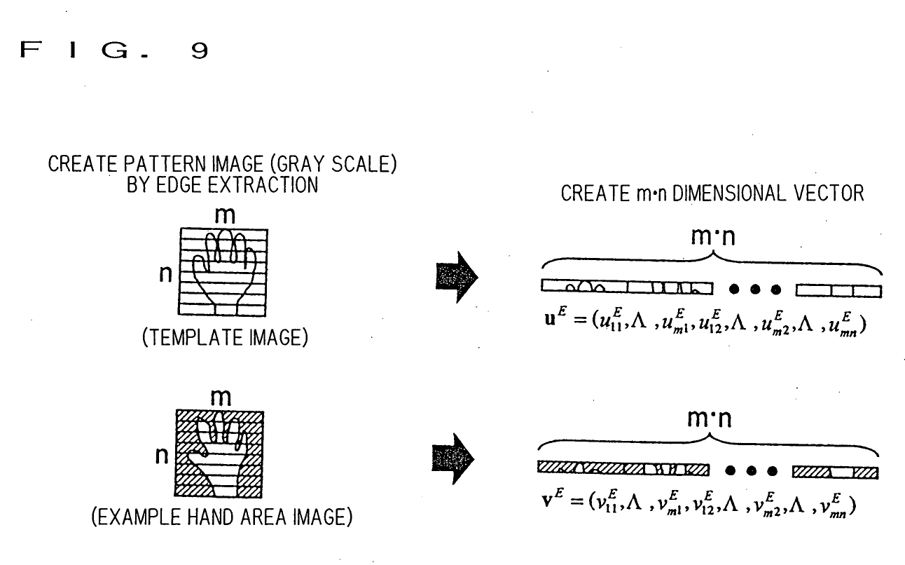

The calculation of the distance on the feature image to represent the pattern of the hand is performed at step S333 in the following procedure. First, when the number of pixels of the template image and the example hand area image is made m×n, a raster scan is performed as shown in FIG. 9, so that vectors u^{E} and v^{E} each having dimensionality of m×n are created. Next, the distance d^{E} is calculated using expression (1).
d^{E}=(u^{E}, v^{E})=1=<u^{E},v^{E}> (1)

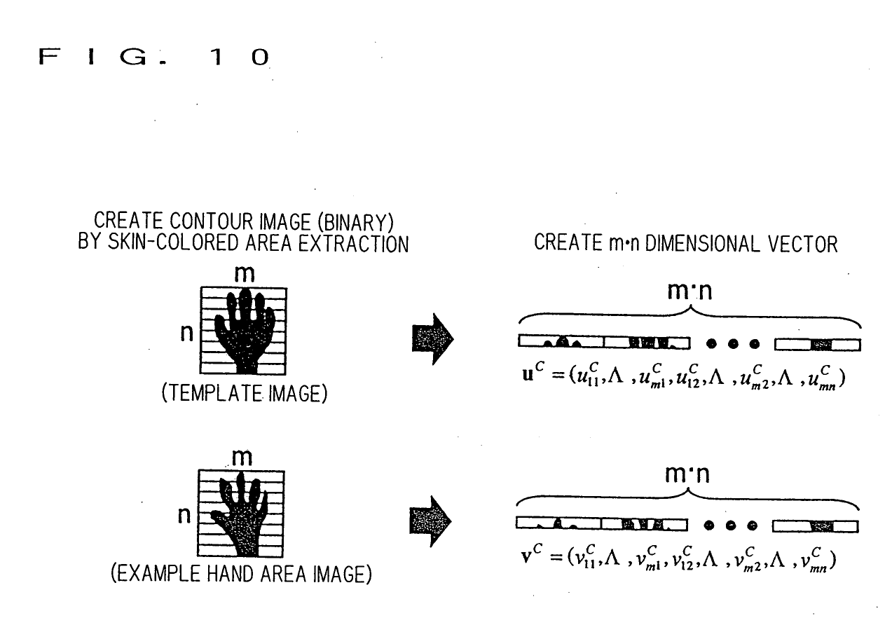

The calculation of the distance on the feature image to represent the contour of the hand is performed at step S333 by the following procedure. First, when the number of pixels of the template image and the example hand area image is m×n, a raster scan is performed as shown in FIG. 10, so that vectors u^{E} and v^{E} each having dimensionality of m×n are created. Next, the distance d^{c} is calculated by using expression (2).

$${d}^{C} ( {u}^{C} , {v}^{C} ) = \frac{1}{m \cdot n} {\sum }_{i = 1}^{m} {\sum }_{j = 1}^{n} ( {u}_{ij}^{C} ⊕ {v}_{ij}^{C} ) \qquad ( 2 )$$

The two distances obtained in the manner described above are made elements and the similarity d={d^{E}, d^{c}} between the template image and the example hand area image is outputted at step S334.

[5-3] Step S35

Referring back to the flowchart of FIG. 7, the description of the template creation/storage processing will be continued.

At step S35, from the eᵢ similarities calculated by the similarity calculation unit 32, the consistency probability distribution creation unit 33 calculates, as an n-dimensional normal distribution Nᵢ=(μᵢ, Σᵢ), the probability distribution of similarities between the hand area images and the template image of the hand shape i in the case where the hand area images have the hand shape i. FIG. 11 is a graph showing the distribution of similarities calculated in the case where the two kinds of features, the pattern of the hand and the contour thereof, are used. From the distribution of these similarities, a two-dimensional normal distribution Nᵢ is calculated. The obtained normal distribution Nᵢ is stored as the consistency probability distribution Nᵢ corresponding to the template image of the hand shape i into the consistency probability distribution storage unit 34.

The processing of the above steps S31 to S35 is performed on the hand shape 1 to the hand shape g, so that the consistency probability distributions {N₁, . . . , N_{g}} corresponding to the respective hand shapes are calculated, and these are stored in the consistency probability distribution storage unit 34.

[6] Gesture Recognition Processing

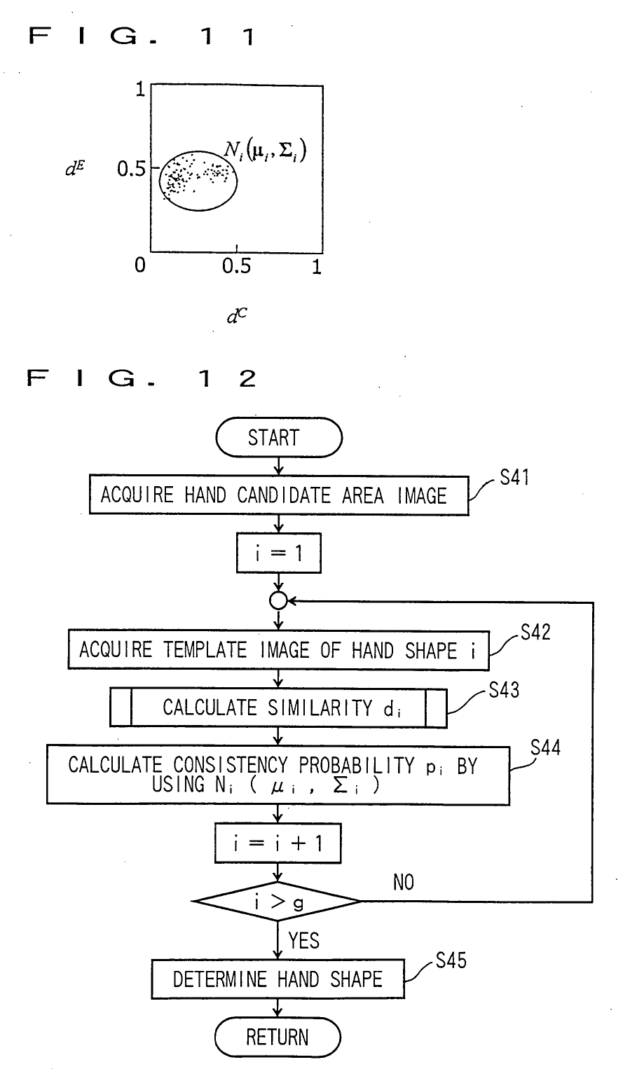

Next, a gesture recognition processing to be executed by the gesture recognition unit 4 will be described with reference to a flowchart of FIG. 12.

At step S41, the gesture recognition unit 4 acquires the hand candidate area image from the hand candidate area detection unit 2, normalizes this into the size of the template image, and supplies it as the second image to the similarity calculation unit 41.

At step S42, the gesture recognition unit 4 acquires the template image corresponding to the hand shape i from the image storage unit 31 of the template creation/storage unit 3, and supplies it as the first image to the similarity calculation unit 41.

At step S43, the similarity calculation unit 41 evaluates similarity between the two supplied images (the hand candidate area image and the template image), and outputs the result as a similarity dᵢ. Here, the feature similar to the similarity calculation processing in the template creation/storage unit 3 is used, and the similarity calculation processing is performed by the method recited in the flowchart of FIG. 8.

At step S44, the consistency probability calculation unit 42 acquires the template consistency probability distribution Nᵢ=(μᵢ, Σᵢ) corresponding to the hand shape i from the consistency probability distribution storage unit 34 of the template creation/storage unit 3, and calculates, from the similarity dᵢ calculated in the similarity calculation unit 41 and by using the probability density function of expression (3), the consistency probability pᵢ that the hand shape included in the hand candidate area image is the hand shape i.

$${p}_{i} = \frac{1}{{( 2 π )}^{n / 2} {\vert {\sum }_{i} \vert}^{1 / 2}} exp ( - \frac{1}{2} {( {d}_{i} - {μ}_{i} )}^{t} {\sum }_{i}^{- 1} ( {d}_{i} - {μ}_{i} ) ) \qquad ( 3 )$$

The processing of the above steps S42 to S44 is performed on the hand shape 1 to the hand shape g, so that the consistency probabilities {p₁, . . . , p_{g}} that the hand shape included in the hand candidate area image is the respective hand shapes are calculated.

At step S45, the hand shape determination unit 43 selects the hand shape having the highest probability from the consistency probabilities calculated in the consistency probability calculation unit 42 and corresponding to the respective hand shapes, and outputs this as the recognition result.

That is, in this gesture recognition processing, first, the similarity d₁ between the one inputted hand candidate area image and the template image of the hand shape 1 is calculated. Next, the probability pᵢ that the similarity d₁ is included in the template consistency probability distribution N₁=(μ₁, Σ₁) is calculated. Then, with respect to this processing, the same calculation is performed for the template images of the hand shape 2 to the hand shape g with respect to the one hand candidate area image, and the probabilities {p₁, . . . , p_{g}} are calculated. Finally, the hand shape corresponding to the highest probability p among them is outputted as the recognition result.

[7] Effects of this Embodiment

As described above, in the hand shape recognition apparatus of the first embodiment, since the recognition of the gesture is performed based on two or more kinds of features, even in the case where one of the features can not be suitably extracted by the change of the environment such as the illumination or background, the similarity between the hand candidate area image and the template image can be suitably evaluated based on the other extracted feature, and therefore, high recognition performance against the change of the environment can be realized.

### Second Embodiment

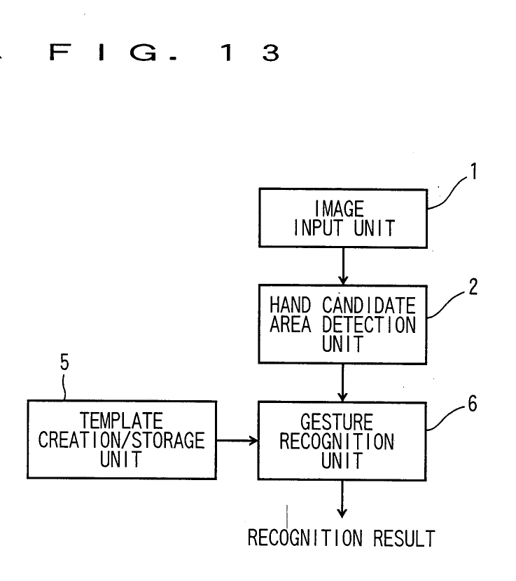

Hereinafter, a hand shape recognition apparatus of a second embodiment will be described with reference to FIGS. 13 to 18.

[1] Object of the Second Embodiment

In the hand shape recognition apparatus of the first embodiment, the high recognition performance is realized by performing the recognition of the gesture by using the consistency probability distribution based on two or more kinds of features. However, since the hand shape is determined based on only the probability that the hand shapes are consistent with each other, in the case where a difference in similarity is small between a case where the hand shapes are consistent with each other and a case where they are not coincident is small, a possibility of erroneous recognition becomes high.

Then, in the hand shape recognition apparatus of the second embodiment, in addition to the consistency probability that the hand shape included in the hand candidate area image is consistent with the hand shape of the template, an inconsistency probability that the hand shapes are not consistent with each other is also calculated, and the hand shape is determined using these probabilities, so that the high recognition performance is realized.

[2] Structure of the Hand Shape Recognition Apparatus

FIG. 13 is a block diagram showing a structure of the hand shape recognition apparatus of the second embodiment.

As shown in FIG. 13, this embodiment is different from the first embodiment in that the functions of a template creation/storage unit 5 and a gesture recognition unit 6 are changed. In the subsequent description, a block having the same structure and function as that of the first embodiment is denoted by the same symbol and its explanation will be omitted.

[3] Template Creation/Storage Unit 5

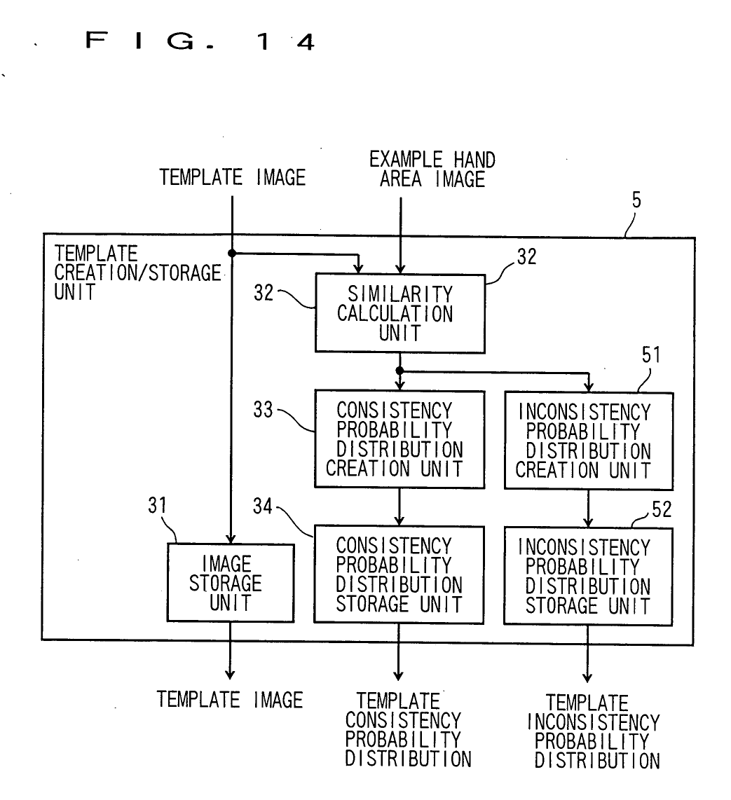

FIG. 14 is a block diagram showing a structure of the template creation/storage unit 5. As compared with the template creation/storage unit 3 of FIG. 4, this embodiment is different in that an inconsistency probability distribution creation unit 51 and an inconsistency probability distribution storage unit 52 are added.

Since an image storage unit 31, a similarity calculation unit 32, a consistency probability distribution creation unit 33 and a consistency probability distribution storage unit 34 have the same functions as those of FIG. 4, their explanation here will be omitted.

From the similarity between the template image and the example hand area image calculated in the similarity calculation unit 32, the inconsistency probability distribution creation unit 51 creates, for each hand shape, a probability distribution (hereinafter referred to as “inconsistency probability distribution”) of similarities outputted by the similarity calculation unit 32 in the case where the hand shape of the hand area image is not consistent with the hand shape of the template image.

The inconsistency probability distribution storage unit 52 stores, as a template inconsistency probability distribution, the inconsistency probability distribution created in the inconsistency probability distribution creation unit 51 and corresponding to each hand shape.

[4] Gesture Recognition Unit 6

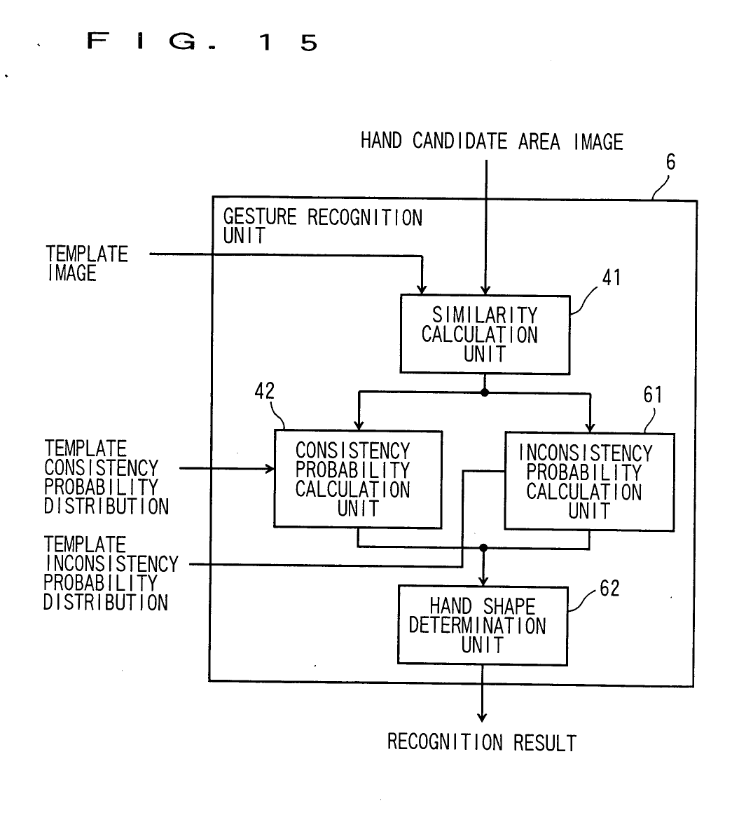

FIG. 15 is a block diagram showing a structure of the gesture recognition unit 6. As compared with the gesture recognition unit 4 of FIG. 6, this embodiment is different in that an inconsistency probability calculation unit 61 is added and the function of a hand shape determination unit 62 is changed.

Since a similarity calculation unit 41 and a consistency probability calculation unit 42 have the same functions as those of FIG. 6, their explanation here will be omitted.

From the similarities calculated in the similarity calculation unit 41 and the template inconsistency probability distribution stored in the inconsistency probability distribution storage unit 52 of the template creation/storage unit 5, the inconsistency probability calculation unit 61 calculates the probability that the hand shape included in the hand candidate area is not consistent with the hand shape of each template.

From the values of the consistency probability calculated in the consistency probability calculation unit 42 and the inconsistency probability calculated in the inconsistency probability calculation unit 61, the hand shape determination unit 62 determines the hand shape having the highest ratio of the consistency probability to the inconsistency probability to be the hand shape of the hand candidate area image, and outputs it as the recognition result.

[5] Template Creation/Storage Processing

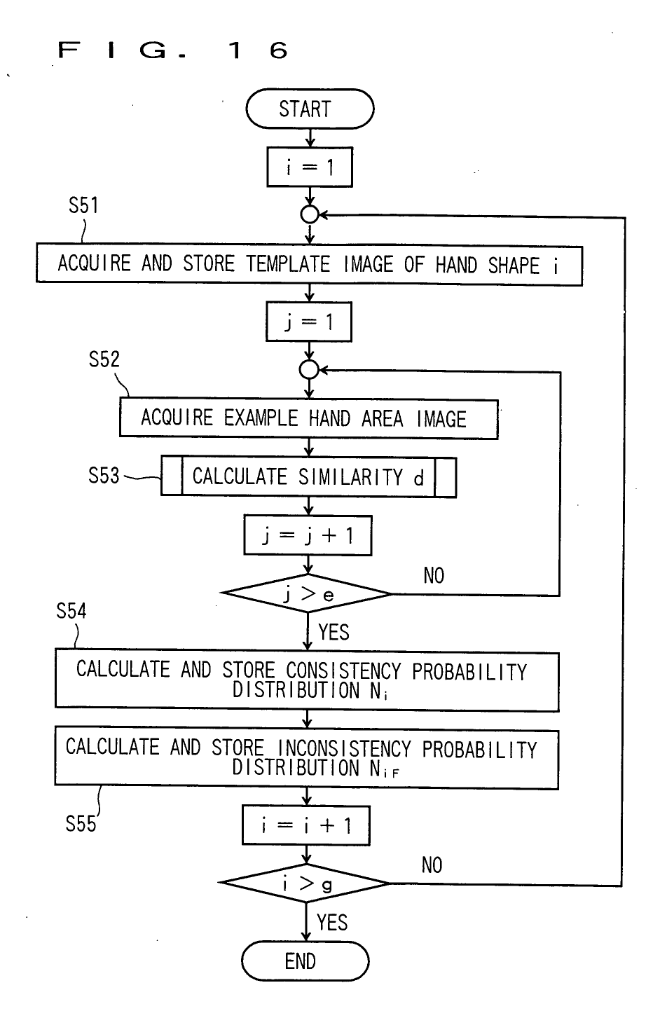

Next, a template creation/storage processing to be executed by the template creation/storage unit 5 will be described with reference to a flowchart of FIG. 16. In FIG. 16, the number of templates to be created is made g, and the total number of example hand shape images is made e.

At step S51, the template creation/storage unit 5 acquires a template image corresponding to a hand shape i, and stores it in the image storage unit 31. At the same time, the acquired template image is supplied as a first image in the similarity calculation unit 32.

At step S52, the template creation/storage unit 5 acquires one example hand shape image and supplies it as a second image in the similarity calculation unit 32. Here, differently from the processing of step S32 in FIG. 7, all example hand shape images are made processing objects irrespective of the hand shape.

At step S53, the similarity calculation unit 32 calculates the similarity between the two supplied images. Since the content of the similarity calculation processing is the same as that of the first embodiment, the explanation here will be omitted.

The processing of the above steps S52 to S53 is performed on the e example hand shape images, so that the similarities between the template image corresponding to the first hand shape and the respective e example hand shape images are obtained.

At step S54, the consistency probability distribution creation unit 33 uses only some of the values of the e similarities calculated by the similarity calculation unit 32, which correspond to the example hand shape image having the hand shape i, calculates, as an n-dimensional normal distribution Nᵢ=(μᵢ, Σᵢ), the probability distribution of similarities between the template image of the hand shape i and the hand area images in the case where the hand area images have the hand shape i, and stores this into the consistency probability distribution storage unit 34.

At step S55, the inconsistency probability distribution creation unit 51 uses only some of the values of the e similarities calculated by the similarity calculation unit 32, which correspond to the example hand shape images not having the hand shape i, calculates, as an n-dimensional normal distribution N_{iF}=(μ_{iF}, Σ_{iF}), the probability distribution of similarities between the template image of the hand shape i and the hand area images in the case where the hand area images do not have the hand shape i, and stores this into the inconsistency probability distribution storage unit 52.

FIG. 17 shows a two-dimensional distribution of similarities obtained in the case where the two kinds of features, the pattern of the hand and the contour thereof, are used, which has been described as the example in the description of the similarity calculation processing of FIG. 8. The two-dimensional normal distributions Nᵢ and N_{iF} are calculated from the distribution of similarities, and these are stored as the consistency probability distribution and the inconsistency probability distribution into the consistency probability distribution storage unit 34 and the inconsistency probability distribution storage unit 52, respectively.

The processing of the above steps S51 to S55 is performed on the hand shape 1 to the hand shape g, so that the templates corresponding to the respective hand shapes are created.

[6] Gesture Recognition Processing

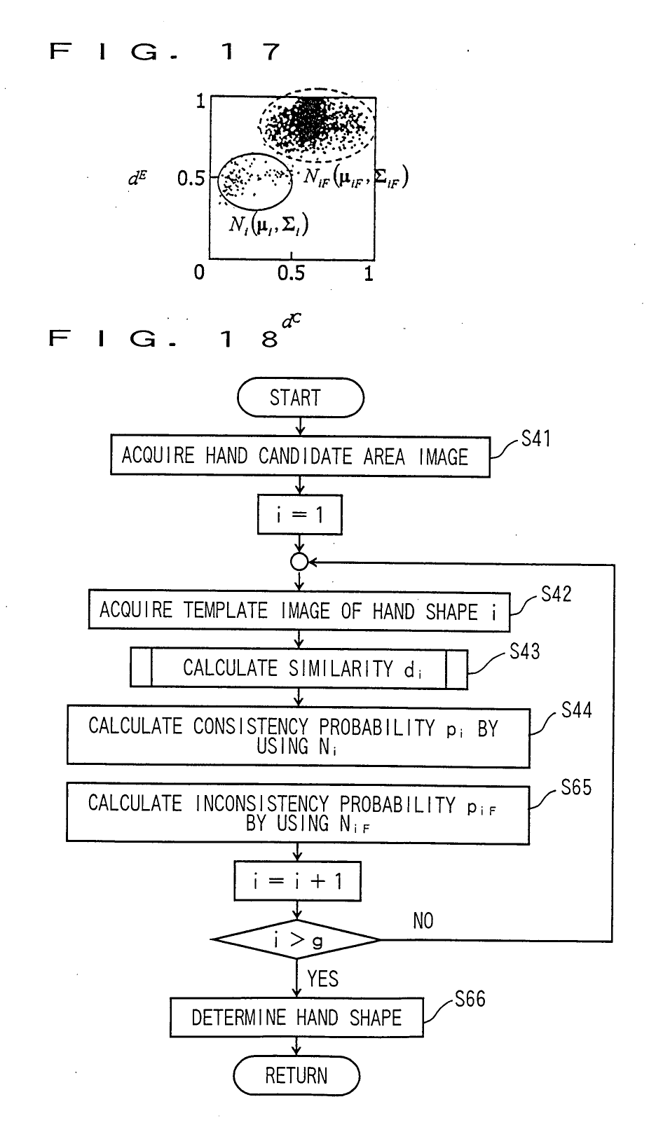

Next, a gesture recognition processing to be executed by the gesture recognition unit 6 will be described with reference to a flowchart of FIG. 18.

Since the processing of steps S41 to S44 is identical to that of the gesture recognition processing explained in FIG. 12, the explanation here will be omitted.

At step S65, the inconsistency probability calculation unit 61 acquires the template inconsistency probability distribution N_{iF}=(μ_{iF}, Σ_{iF}) corresponding to the hand shape i from the inconsistency probability distribution storage unit 52 of the template creation/storage unit 5, and calculates, from the similarity dᵢ calculated in the similarity calculation unit 41 and by using a probability density function of expression (4), an inconsistency probability p_{iF} that the hand shape included in the hand candidate area image is not the hand shape i.

$${p}_{iF} = \frac{1}{{( 2 π )}^{n / 2} {\vert {\sum }_{iF} \vert}^{1 / 2}} exp ( - \frac{1}{2} {( {d}_{i} - {μ}_{iF} )}^{t} {\sum }_{iF}^{- 1} ( {d}_{i} - {μ}_{iF} ) ) \qquad ( 4 )$$

The processing of the above steps S42 to S44 and S65 is performed on the hand shape 1 to the hand shape g to calculate the inconsistency probabilities {p_{1F}, . . . , p_{gF}} that the hand shape included in the hand candidate area image is not consistent with the respective hand shapes.

At step S66, the hand shape determination unit 62 selects, for each hand shape, the most probable hand shape as the hand shape included in the hand candidate area image from the values of the consistency probability and the inconsistency probability calculated in the consistency probability calculation unit 42 and the inconsistency probability calculation unit 61, and outputs this as the recognition result. As a judgment method of certainness, there is conceivable a method in which attention is paid to a difference in magnitude between the consistency probability pᵢ and the inconsistency probability p_{iF}, for example, a method in which a difference between the consistency probability pᵢ and the inconsistency probability p_{iF} is obtained for each hand shape, and the hand shape with the largest difference is made the hand shape to be obtained, or a method of obtaining a hand shape in which a value obtained by dividing the consistency probability pᵢ by the inconsistency probability p_{iF} is largest.

[7] Effects of the Embodiment

As described above, in the hand shape recognition apparatus of the second embodiment, since the recognition of the gesture is performed using the inconsistency probability in addition to the consistency probability, also in the case where a large difference does not occur in the similarity between the case where the hand shapes of the template image and the hand candidate area image are coincident with each other and the case where they are not coincident, high recognition performance can be realized.

### Third Embodiment

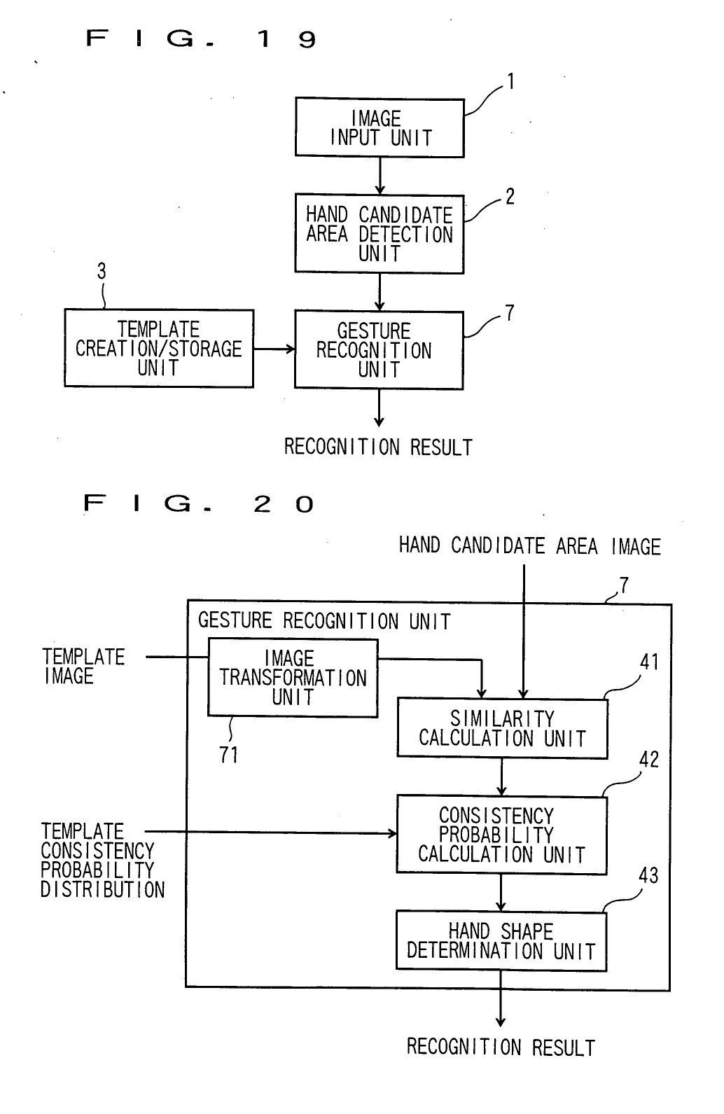

Hereinafter, a hand shape recognition apparatus of a third embodiment will be described with reference to FIGS. 19 to 22.

[1] Object of the Third Embodiment

In the above respective embodiments, the hand shape is identified by comparing the template image with the hand candidate area image. When the gesture recognition processing is performed, the size of the hand candidate area image is normalized to the size of the template image, so that the hand shape can be recognized irrespective of the distance between an image input apparatus and the hand.

However, in the hand candidate area detection processing, in the case where features used for the processing can not be suitably detected due to the influence of an environment such as illumination or background, or in the case where the direction of a hand in the hand candidate area is different from the direction of a hand in the template image, there is a case where a suitable hand shape can not be determined even if the above normalization is performed.

Then, in the hand shape recognition apparatus of the third embodiment, an image transformation part to perform transformation of a template image is provided, so that the identification of the hand shape is realized even in the case where the hand shape area can not be suitably extracted, or in the case where the direction of the hand in the hand candidate area image is different from the direction of the hand in the template image.

[2] Structure of the Hand Shape Recognition Apparatus

FIG. 19 is a block diagram showing a structure of the hand shape recognition apparatus of the third embodiment.

As shown in FIG. 19, this embodiment is different from the first embodiment in that the function of a gesture recognition unit 7 is changed. In the following description, a block having the same structure and function as that of the first embodiment is denoted by the same symbol, and its explanation will be omitted.

[3] Gesture Recognition Unit 7

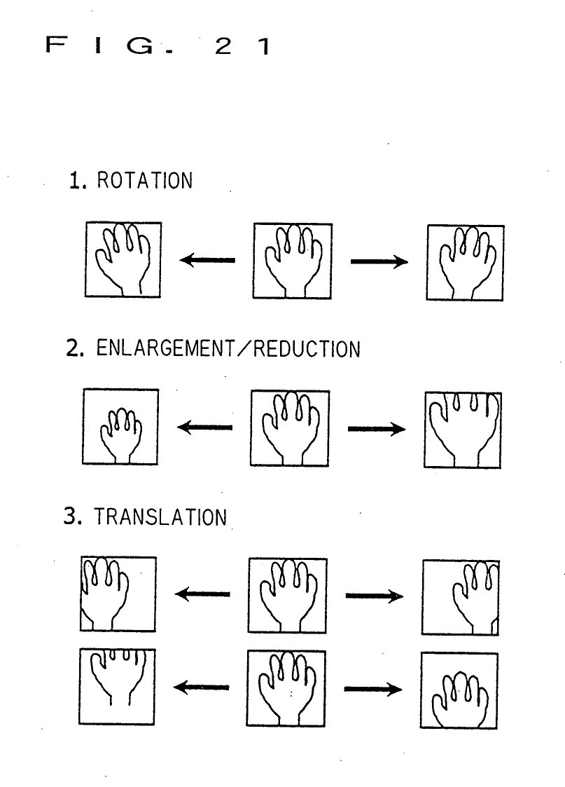

FIG. 20 is a block diagram showing a structure of the gesture recognition unit 7. As compared with the gesture recognition unit 4 of FIG. 6, this embodiment is different in that an image transformation unit 71 is newly added.

Since a similarity calculation unit 41, a consistency probability calculation unit 42, and a hand shape determination unit 43 have the same functions as those of FIG. 6, their explanation here will be omitted.

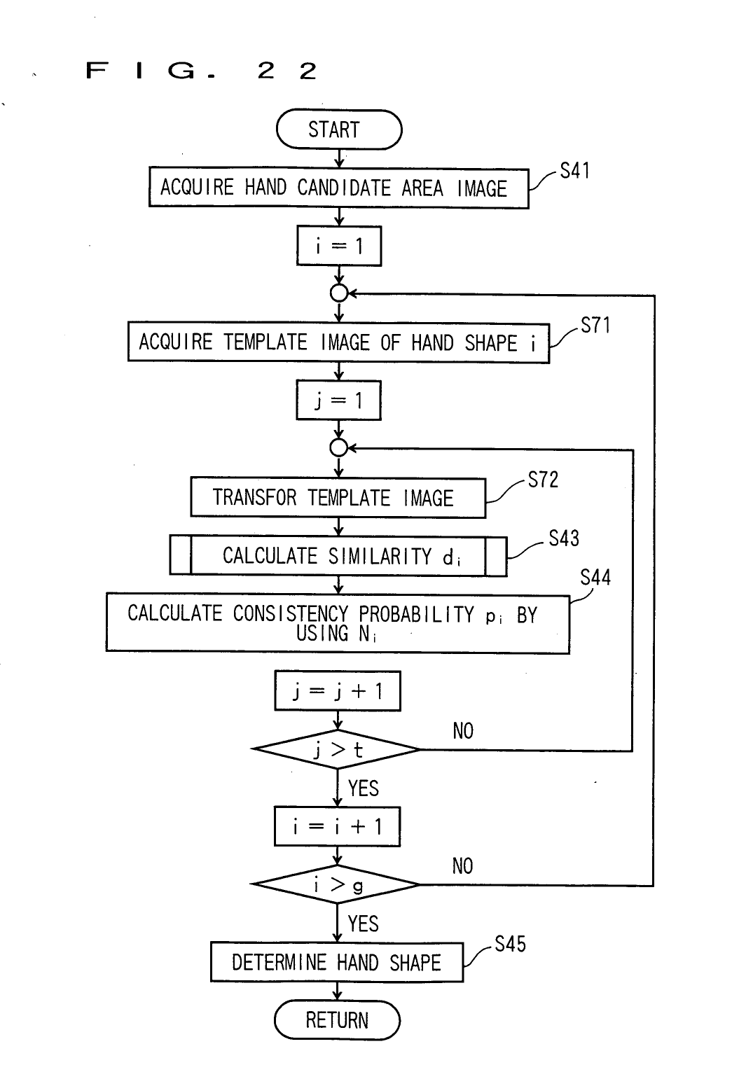

The image transformation unit 71, as shown in FIG. 21, has a function to transform an input image by rotation, enlargement/reduction, translation and combination of these.

[4] Gesture Recognition Processing

Next, a gesture recognition processing to be executed by the gesture recognition unit 7 will be described with reference to a flowchart of FIG. 22.

At step S41, the gesture recognition unit 7 acquires a hand candidate area image, normalizes this to the size of a template image, and supplies it as a second image in the similarity calculation unit 41.

At step S71, the gesture recognition unit 7 acquires the template image corresponding to the first hand shape, and supplies it to the image transformation unit 71.

At step S72, the image transformation unit 71 creates an image obtained by transforming the template image given as the input by the rotation, enlargement/reduction, translation or combination of these, and supplies this as a first image in the similarity calculation unit 41.

The transformation of the image is performed using, for example, a matrix as indicated below.

$$T = ( \begin{matrix}s \cdot cos θ & - s \cdot sin θ & tx \\ s \cdot sin θ & s \cdot cos θ & ty \\ 0 & 0 & 1\end{matrix} ) \qquad ( 5 )$$

In expression (5), θ, s, tx and ty denote a rotation angle, an enlargement rate, and movement amounts in an X direction and a Y direction, respectively.

With respect to the template image subjected to the transformation and the inputted hand candidate area image, the processing of step S43 and S44 is performed to calculate the hand shape consistency probability of the two images. Since the content of the processing at these steps is the same as that of the corresponding steps of FIG. 12, the explanation here will be omitted.

With respect to the consistency probability of the hand shape used at step S45, a template is modified using t parameters for each hand shape, consistency probabilities are calculated for the respective parameters, and the maximum probability among these is used.

[5] Effects of the Embodiment

As described above, in the hand shape recognition apparatus of the third embodiment, since the image transformation unit to transform the template image is provided, even in the case where the hand candidate area is not suitably extracted, or in the case where the direction of the hand in the hand candidate area image is different from the direction of the hand in the template image, as long as it is within a certain range, a suitable hand shape can be selected and outputted.

### MODIFIED EXAMPLE

The above respective embodiments are examples for carrying out the invention, and the invention is not limited to the respective embodiments. The embodiments can be variously modified within the scope not departing from the gist of the invention.

For example, although a judgment is made using only the consistency probability distribution in the first embodiment, and a judgment is made using the consistency probability distribution and the inconsistency probability distribution in the second embodiment, a judgment may be made using only an inconsistency probability distribution as a modified example.

What is claimed is:

1. An apparatus for recognizing a shape of a human hand, comprising:
an image input unit configured to input an image containing the human hand;
a hand candidate area detection unit configured to detect a hand candidate area from the input image;
a template storage unit configured to store a plurality of template images and a plurality of consistency probability distributions, the template images relating to a plurality of hand shapes, the consistency probability distributions corresponding to the respective template images, each of the consistency probability distributions indicating a probability distribution based on a distribution of first similarities between each of the template images and a plurality of example hand area images each containing a hand shape consistent with the hand shape of the respective template image; and
a hand shape recognition unit configured (1) to calculate second similarities between the hand candidate area image and each of the template images relating to the respective hand shapes, (2) to calculate plural consistency probabilities that each of the second similarities is included in the consistency probability distribution corresponding to each of the template images relating to the respective hand shapes, and (3) to obtain a hand shape most similar to the hand candidate area image based on the plural consistency probabilities.

2. The hand shape recognition apparatus according to claim 1, wherein the hand shape recognition unit recognizes a hand shape corresponding to the template image having the highest probability among the plural consistency probabilities to be the hand shape most similar to the hand candidate area image.

3. The hand shape recognition apparatus according to claim 1, wherein the template storage unit
calculates, for each of the template images relating to the respective hand shapes, the first similarities between the template image and the plurality of example hand area images, and
calculates the consistency probability distribution corresponding to each of the template image based on the distribution of the first similarities.

4. The hand shape recognition apparatus according to claim 1, wherein the template storage unit
(1) calculates third similarities between a template image in which an arbitrary hand shape is previously photographed and plural example hand area images in which a hand shape different from the arbitrary hand shape, together with a background, is previously photographed and which are different from each other in only the background and an illumination condition,
(2) calculates a distribution of the third similarities as an inconsistency probability distribution,
(3) obtains the inconsistency probability distribution for each of the template images relating to plural hand shapes, and
(4) stores the respective template images and the consistency probability distributions corresponding to the respective template images, and
the hand shape recognition unit
(1) calculates plural inconsistency probabilities included in the inconsistency probability distributions corresponding to the template images relating to the respective hand shapes, and
(2) obtains the hand shape most similar to the hand candidate area image based on the plural consistency probabilities and the plural inconsistency probabilities.

5. The hand shape recognition apparatus according to claim 4, wherein the hand shape recognition unit subtracts the plural consistency probabilities from the plural inconsistency probabilities for the respective hand shapes, and recognizes a hand shape with the largest difference to be the hand shape most similar to the hand candidate area image.

6. The hand shape recognition apparatus according to claim 1, further comprising a similarity calculation unit configured to obtain the first similarity, the second similarity or the third similarity,
wherein the similarity calculation part
(1) creates n kinds of feature images on one image,
(2) creates n kinds of feature images on another image to be compared with the one image,
(3) compares the feature images of the one image with the feature images of the another image for the respective kinds to calculate n distances of both, and
(4) determines the n distances to be the first similarity, the second similarity or the third similarity.

7. The hand shape recognition apparatus according to claim 1, further comprising an image transformation unit configured to create an image modified by applying an operation of rotation, enlargement/reduction, translation or combination of these to the input image,
wherein the hand shape recognition unit modifies the template image or the hand candidate area image by using the image transformation unit to maximize the consistency probability.

8. The hand shape recognition apparatus according to claim 1, wherein the hand candidate area detection unit obtains a mixture of normal distribution relating to a possibility of the hand candidate area from at least one kind of feature information extracted from the input image and a position of the hand candidate area in a past frame, and determines the hand candidate area image in a present frame based thereon.

9. A method for recognizing a shape of a human hand, comprising:
inputting an image containing the human hand;
detecting a hand candidate area from the input image;
storing a plurality of template images and a plurality of consistency probability distributions, the template images relating to a plurality of hand shapes, the consistency probability distributions corresponding to the respective template images, each of the consistency probability distributions indicating a probability distribution based on a distribution of first similarities between each of the template images and a plurality of example hand area images each containing a hand shape consistent with the hand shape of the respective template image;
(1) calculating second similarities between the hand candidate area image and each of the template images relating to the respective hand shapes; (2) calculating plural consistency probabilities that each of the second similarities is included in the consistency probability distribution corresponding to each of the template images relating to the respective hand shapes; and (3) obtaining a hand shape most similar to the hand candidate area image based on the plural consistency probabilities.

10. A program product for recognizing a shape of a human hand, the program product comprising instructions of:
inputting an image containing the human hand;
detecting a hand candidate area from the input image;
storing a plurality of template images and a plurality of consistency probability distributions, the template images relating to a plurality of hand shapes, the consistency probability distributions corresponding to the respective template images, each of the consistency probability distributions indicating a probability distribution based on a distribution of first similarities between each of the template images and a plurality of example hand area images each containing a hand shape consistent with the hand shape of the respective template image;
(1) calculating second similarities between the hand candidate area image and each of the template images relating to the respective hand shapes; (2) calculating plural consistency probabilities that each of the second similarities is included in the consistency probability distribution corresponding to each of the template images relating to the respective hand shapes; and (3) obtaining a hand shape most similar to the hand candidate area image based on the plural consistency probabilities.
